(19) United States
(12) Patent Application Publication
(10) Pub. No.: US 2025/0354637 A1
(43) Pub. Date: Nov. 20, 2025

(54) BLEED RINGS AND METHODS

(71) Applicant: Titan Flow Control, Inc., Lumberton, NC (US)

(72) Inventor: Geoffrey Walton McLean, Lumberton, NC (US)

(21) Appl. No.: 19/207,732

(22) Filed: May 14, 2025

Related U.S. Application Data
(63) Continuation of application No. 29/942,212, filed on May 14, 2024.
(60) Provisional application No. 63/647,315, filed on May 14, 2024.

(51) Int. Cl. F16L 23/00

(52) U.S. Cl. CPC F16L 23/006

(57) ABSTRACT

A bleed ring includes an annular body defining a substantially cylindrical outer surface, a substantially cylindrical inner surface, a first coupling surface extending between the outer surface and the inner surface, and a second coupling surface substantially opposing the first coupling surface. One or more tap can extend between the outer surface and the inner surface. Scalloped cavities can be disposed in the outer surface. In this configuration, the inner surface has a diameter corresponding to a standard pipe size, the outer surface has a diameter configured to fit within a first arrangement of flange bolts associated with a first pressure class of the standard pipe size, and the scalloped cavities are configured to align with a second arrangement of flange bolts associated with a second pressure class of the standard pipe size.

### CROSS-REFERENCE TO RELATED APPLICATION

The present application claims the benefit of and priority to U.S. Patent App. Ser. No. 63/647,315, filed May 14, 2024, and U.S. Design patent application Ser. No. 29/942,212, filed May 14, 2024, the disclosures of which are each incorporated herein by reference in their entireties.

### TECHNICAL FIELD

The subject matter disclosed herein relates generally to pipe flanges and flanged fittings and associated methods. More particularly, the subject matter disclosed herein relates to bleed rings configured to fit between standard pipe flanges and flanged fittings.

### BACKGROUND

Bleed rings are accessory devices that can be used to provide easy access to a piping system in order to drain piping, take samples, or attach instruments to pipe lines. Bleed rings are a ring section with one or more radial pipe connections designed to fit between standard flanges, such as nestled within the circle formed by the flange bolting. Conventional bleed rings are round and manufactured with at least one ½-inch or ¾-inch tapping to allow easy connection of valves and instruments. To fit between standard flanges, conventional bleed rings are sized and configured to correspond to the dimensions and class characteristics of the pipe flange with which the bleed ring is intended to be coupled. Specifically, bleed rings are normally round and designed to nestle inside the bolting circle of a corresponding flange. In this regard, a different bleed ring configuration can be optimized for each flange diameter and pressure class service.

### SUMMARY

In accordance with this disclosure, devices and methods for providing access to a piping system at flanged junctions are provided. In one aspect, a bleed ring includes an annular body defining a substantially cylindrical outer surface, a substantially cylindrical inner surface, a first coupling surface extending between the outer surface and the inner surface, and a second coupling surface substantially opposing the first coupling surface. One or more tap can extend between the outer surface and the inner surface. A plurality of scalloped cavities can be arranged in the outer surface. In some embodiments, the inner surface has a diameter corresponding to a standard pipe size. In some embodiments, the outer surface has a diameter configured to fit within a first arrangement of flange bolts associated with a first pressure class of the standard pipe size. In some embodiments, the scalloped cavities are configured to align with a second arrangement of flange bolts associated with a second pressure class of the standard pipe size.

In another aspect, a method for coupling elements in a piping system can include arranging an annular body between a first pipe flange and a second pipe flange, the annular body defining a substantially cylindrical inner surface having a diameter corresponding to a standard pipe size and a substantially cylindrical outer surface including a plurality of scalloped cavities formed therein. In this arrangement, a first coupling surface extending between the outer surface and the inner surface can be arranged against the first pipe flange, and a second coupling surface substantially opposing the first coupling surface can be arranged against the second pipe flange. The first pipe flange can be coupled to the second pipe flange using a plurality of flange bolts. In this arrangement, the outer surface can have a diameter that is configured such that, where the first pipe flange and the second pipe flange are sized to correspond to a first pressure class of the standard pipe size, and the plurality of flange bolts couple the first pipe flange to the second pipe flange in a first arrangement corresponding to the first pressure class, the outer surface fits within the first arrangement of the plurality of flange bolts. Alternatively, the plurality of scalloped cavities can be configured such that, where the first pipe flange and the second pipe flange are sized to correspond to a second pressure class of the standard pipe size, and the plurality of flange bolts couple the first pipe flange to the second pipe flange in a second arrangement corresponding to the second pressure class, the plurality of scalloped cavities can be aligned with the second arrangement of the plurality of flange bolts.

Although aspects of the subject matter disclosed herein have been stated hereinabove, and which is achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a perspective side view of a bleed ring according to an embodiment of the presently disclosed subject matter;

FIG. 2 is a top plan view of a bleed ring according to an embodiment of the presently disclosed subject matter; and

FIG. 3 is a side perspective view of a bleed ring installed at a junction between two pipe flanges.

### DETAILED DESCRIPTION

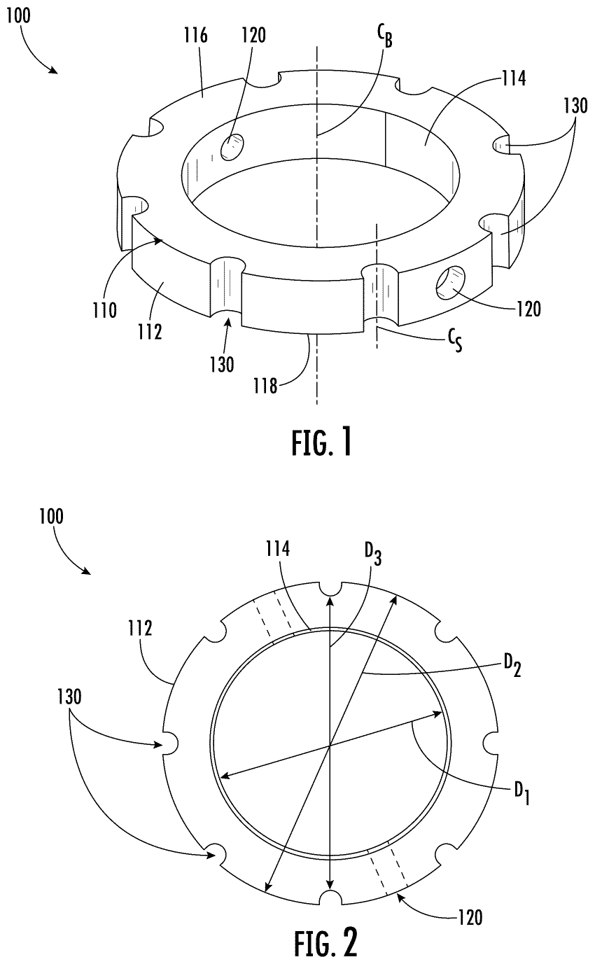

The present subject matter provides a bleed ring configuration that is operable with multiple pressure classes of pipe for a given standard pipe diameter. In the embodiment illustrated in FIG. 1, the bleed ring, generally designated 100, includes an annular body 110 that defines a substantially cylindrical outer surface 112, a substantially cylindrical inner surface 114, a first coupling surface 116 extending between the outer surface 112 and the inner surface 114, and a second coupling surface 118 substantially opposing the first coupling surface 116. In some embodiments, one or both of the first coupling surface 116 or the second coupling surface 118 has a serrated or otherwise textured finish configured to enhance the coupling of the bleed ring 100 with adjacent pipe flanges or other flanged fittings.

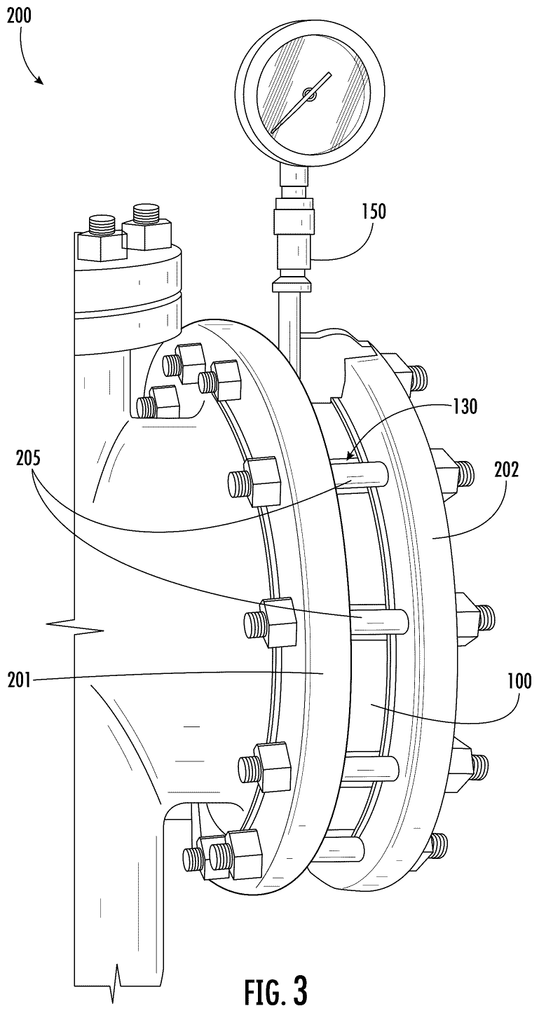

In some embodiments, the bleed ring 100 further includes one or more tap 120 extending between the outer surface and the inner surface. Although the configuration shown in FIG. 1 has two taps 120 arranged on substantially opposing sides of the annular body 110, those having ordinary skill in the art will recognize that other configurations could be implemented. In some examples, a single tap 120 can be arranged in the edge of the annular body 110. Alternatively, in some other examples, multiple taps 120 can be arranged in the edge of the annular body 110. In such a configuration, the multiple taps can be substantially aligned on opposing sides of the annular body 110 as illustrated, or they can be arranged asymmetrically about the edge of the annular body 110. In any configuration, as discussed above, the one or more tap 120 can define an opening or hole extending entirely through bleed ring 100 from outer surface 112 to inner surface 114 and be configured to couple an instrument 150 (such as in FIG. 3), such as a sensor, gauge, sample valve, or anode rod, to the bleed ring 100 or to otherwise provide access into the piping system for draining, venting, etc. To achieve this coupling, in some embodiments, each of the one or more tap 120 can be at least partially threaded to correspondingly receive a threaded coupler of the instrument 150 (See, e.g., FIG. 3). Conventional sizes for the one or more tap 120 include ½ inch and ¾ inch configurations, although those having ordinary skill in the art will recognize that other sizes or configurations can be used to accommodate the specific needs of a given bleed ring installation.

In addition, the bleed ring 100 includes a plurality of scalloped cavities 130 arranged in the outer surface 112. As shown in FIGS. 1 and 2, for example, each of the scalloped cavities 130 can be provided in the form of a substantially cylindrical bore. In some examples, a centerline C_{S} of each of the scalloped cavities 130 is substantially parallel to a centerline C_{B} of the annular body 110. In this configuration, the bleed ring 110 can be sized and configured for use with multiple pressure classes of pipe for a given standard pipe diameter. Specifically, the inner surface 114 can be configured to have a first diameter D1 corresponding to a standard pipe size. The outer surface 112 can then be configured to have a second diameter D2 that is configured to fit within a first arrangement of flange bolts associated with a first pressure class of the standard pipe size in a manner that is substantially similar to the configuration of conventional round bleed rings.

The addition of the plurality of these scalloped cavities 130, however, can adapt the bleed ring 100 for use with a second pipe flange configuration. In particular, the plurality of scalloped cavities 130 can be configured to align with a second arrangement of flange bolts associated with a second pressure class of the standard pipe size. In some embodiments, such a configuration is achieved by insetting the scalloped cavities 130 into the outer surface 112 to a third diameter D3 that corresponds to the second arrangement of flange bolts associated with the second pressure class of the standard pipe size.

In this configuration, for a given nominal pipe size, the bleed ring 100 can be configured both to fit within the arrangement of bolts of a pipe flange of a first pressure class (e.g., ASME B16.5 Class 300) and to have the plurality of scalloped cavities 130 configured to be in alignment with the arrangement of bolts of a pipe flange of a second pressure class that is lower than the first pressure class (e.g., ASME B16.5 Class 150). In this way, the bleed ring 100 can be configured to be coupled between pipe flanges or flanged fittings having either configuration. Referring to FIG. 3, in a piping system generally designated 200, the bleed ring 100 can be positioned between a first pipe flange 201 and a second pipe flange 202 that are coupled to one another by a plurality of fasteners 205 (e.g., bolts). Depending on the configuration of the bleed ring 100 and the pressure class of the first and second pipe flanges 201 and 202, the bleed ring 100 can be secured entirely within the ring of fasteners 205, or the plurality of scalloped cavities 130 can be arranged to align with the ring of fasteners 205. In this installed position, one or more instrument 150 can be connected to the one or more tap 120 to provide access and/or monitoring of the piping system 200.

In a representative example, for a piping system having a nominal pipe size of 6 inches, the bleed ring 100 can have a first diameter D1 of approximately 6.63 inches to substantially correspond to the standard pipe bore and a second diameter D2 of approximately 9.75 inches. Each of the scalloped cavities 130 can have a diameter of approximately 0.88 inches that is centered about a centerline C_{S} that is inset approximately 0.13 inches into the outer surface 112 of the annular body 110 such that the bleed ring 100 defines a third diameter D3 of approximately 8.63 inches. In this configuration, if the bleed ring 100 is to be used with a flange arrangement in ASME B16.5 Class 300, the entirety of the bleed ring 100 can be arranged within the bolt circle of the Class 300 flange having a diameter of 10.62 inches. Alternatively, if the bleed ring 100 is to be used with a flange arrangement in ASME B16.5 Class 150, the scalloped cavities 130 can be substantially aligned with the bolt positions of the Class 150 flange arranged at a bolt circle diameter of 9.50 inches.

This ability of the bleed ring 100 to be implemented with pipe flanges and flanged fittings corresponding to multiple pressure class services reduces the need to maintain separate inventories of bleed rings for different piping systems. As a result, the present systems can cut down on inventory requirements and allows faster delivery. Those having ordinary skill in the art will recognize that the dimensions of the bleed ring 100 and the arrangement of the scalloped cavities 130 can be adjusted or adapted to enable use of the bleed ring 100 with any desired pair of rating class designations.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A bleed ring comprising:
an annular body defining a substantially cylindrical outer surface, a substantially cylindrical inner surface, a first coupling surface extending between the outer surface and the inner surface, and a second coupling surface substantially opposing the first coupling surface;
a plurality of scalloped cavities in the outer surface;
wherein the inner surface has a diameter corresponding to a standard pipe size;
wherein the outer surface has a diameter configured to fit within a first arrangement of flange bolts corresponding to a first pressure class of the standard pipe size; and
wherein the plurality of scalloped cavities are configured to align with a second arrangement of flange bolts corresponding to a second pressure class of the standard pipe size.

2. The bleed ring of claim 1, wherein one or both of the first coupling surface or the second coupling surface comprises a serrated finish.

3. The bleed ring of claim 1, wherein each of the scalloped cavities comprises a substantially cylindrical bore.

4. The bleed ring of claim 3, wherein a centerline of each of the scalloped cavities is substantially parallel to a centerline of the annular body.

5. The bleed ring of claim 1, wherein the first pressure class is ASME B16.5 Class 300 and the second pressure class is ASME B16.5 Class 150.

6. The bleed ring of claim 1, comprising one or more tap extending between the outer surface and the inner surface.

7. The bleed ring of claim 6, wherein the one or more tap is configured for coupling with an instrument selected from the group consisting of a sensor, a gauge, a drain, a vent, a sample valve, and an anode rod.

8. The bleed ring of claim 7, wherein the one or more tap is at least partially threaded and is configured to correspondingly receive a threaded coupler of the instrument.

9. A method for coupling elements in a piping system, the method comprising:
arranging an annular body between a first pipe flange and a second pipe flange, the annular body defining a substantially cylindrical inner surface having a diameter corresponding to a standard pipe size and a substantially cylindrical outer surface including a plurality of scalloped cavities formed therein, wherein a first coupling surface extending between the outer surface and the inner surface is arranged against the first pipe flange, and wherein a second coupling surface substantially opposing the first coupling surface is arranged against the second pipe flange; and
coupling the first pipe flange to the second pipe flange using a plurality of flange bolts;
wherein the outer surface has a diameter configured such that, where the first pipe flange and the second pipe flange are sized to correspond to a first pressure class of the standard pipe size, and the plurality of flange bolts couple the first pipe flange to the second pipe flange in a first arrangement corresponding to the first pressure class, coupling the first pipe flange to the second pipe flange comprises fitting the outer surface within the first arrangement of the plurality of flange bolts; and
wherein the plurality of scalloped cavities are configured such that, where the first pipe flange and the second pipe flange are sized to correspond to a second pressure class of the standard pipe size, and the plurality of flange bolts couple the first pipe flange to the second pipe flange in a second arrangement corresponding to the second pressure class, coupling the first pipe flange to the second pipe flange comprises aligning the plurality of scalloped cavities with the second arrangement of the plurality of flange bolts.

10. The method of claim 9, wherein the first pressure class is ASME B16.5 Class 300 and the second pressure class is ASME B16.5 Class 150.

11. The method of claim 9, wherein the annular body comprises one or more tap extending between the outer surface and the inner surface; and
wherein the method comprises coupling an instrument to the one or more tap.

12. The method of claim 11, wherein the instrument is selected from the group consisting of a sensor, a gauge, a drain, a vent, a sample valve, and an anode rod.

13. The method of claim 11, wherein the one or more tap is at least partially threaded and the instrument comprises a threaded coupler; and
wherein coupling the instrument to the one or more tap comprises engaging the threaded coupler of the instrument with the one or more tap.
